(19) United States
(12) Patent Application Publication
(10) Pub. No.: US 2014/0310980 A1
(43) Pub. Date: Oct. 23, 2014

(54) DEVICE FOR THE CONTINUOUS TREATMENT OF SOLIDS IN A FLUIDIZED BED APPARATUS

(71) Applicants: Michael Jacob, Weimar (DE); Reinhard Boeber, Weimar (DE)

(72) Inventors: Michael Jacob, Weimar (DE); Reinhard Boeber, Weimar (DE)

(73) Assignee: GLATT INGENIEURTECHNIK GMBH, Weimar (DE)

(21) Appl. No.: 14/116,413

(22) PCT Filed: May 11, 2012
(86) PCT No.: PCT/DE2012/000486

§ 371 Date: Dec. 6, 2013

(30) Foreign Application Priority Data
May 12, 2011 (DE) 10 20110101 866.6

(51) Int. Cl. F26B 17/10

(52) U.S. Cl. CPC F26B 17/10
USPC 34/589

(57) ABSTRACT

The invention relates to a device for continuously treating solids in a fluidized bed apparatus, comprising a round process chamber with a solids inlet and a solids outlet, and a distributor plate which is adapted to the inner contour of the process chamber and beneath which a media inlet is arranged to produce and maintain the fluidized bed. According to the invention, on the distributor plate (1) there is a separating wall (2) that protrudes radially inwards from the process chamber (3, 9) inner wall (10) and into the process chamber (3, 9). The solids inlet (5) is located on one side close to the separating wall (2), and the solids outlet (6) is on the other side close to the separating wall (2). It is particularly advantageous to arrange, on the distributor plate (1) and along the axis of the process chamber (9), a displacer element (8) that is connected to the separating wall (2). This has the advantage that, in a process chamber that has a round cross-section while the fluidized bed is also flat, an evenly directed flow of solids in the horizontal direction is obtained over a longer distance. Such a device allows a narrow spectrum of residence time.

### STATE OF THE ART

The invention proceeds from a device for continuous treatment of solids in a fluidized bed apparatus, for example for the production of freely flowing granulates by means of spray granulation, agglomeration, encapsulation, coating or drying, in accordance with the preamble of claim 1.

In order to achieve end products having defined particle structures, solids are treated in a continuous fluidized bed. For this purpose, devices having a rectangular apparatus geometry are known, in which the material to be treated is transported from its entry into the process space over the length of the device until its exit from the process space by means of corresponding fluidization in the region of the fluidized bed, or flows independently because of a slanted position of the fluidized bed channel. While passing along this path, the material to be treated is brought into contact with the fluidization medium, in each instance, in the fluidized bed.

Every continuously operating apparatus has a characteristic dwell time spectrum that can be influenced by way of the geometry of the process space and process-technology parameters. An additional possibility of affecting the dwell time spectrum consists in the placement of installations in the process space. Thus it is known to provide installations in the form of installed parts, the lower edge of which, in each instance, is at a distance from the surface of the fluidized bed bottom, and the upper edge of which, in each instance, ends at a distance above the surface of the fluidized bed. Furthermore, a greater opening ratio of the gas passage openings of the fluidized bed bottom was selected in the region below the installed parts than in the remaining regions of the fluidized bed bottom. The installed parts have a round, rectangular or polygonal cross-section (DE 101 46 778 A1). By means of the solids flow that is directed uniformly in the longitudinal direction of the process space, a narrow dwell time spectrum is achieved for the material to be treated, using such apparatuses. Furthermore, multiple process steps, for example granulation and drying, can be implemented in one and the same process space.

The disadvantage of devices having a rectangular apparatus geometry, however, consists in that they require a large amount of space and possess a great mass due to their size and the wall thickness that are required because of the technology, and that their production is therefore expensive. Because of their rectangular geometry, they cannot be designed to be pressure-resistant or pressure-surge-resistant at all, or can only be designed in this way with very great effort.

In contrast, it is true that devices having a round apparatus geometry, in which the process space is cylindrical or conical, make do with a lower space requirement and also can more easily be designed to be pressure-resistant or pressure-surge-resistant, but the possibility of implementing different process conditions is restricted. Thus, it is true that ideal mixing of the solids particles takes place in the process space, but the height of the fluidized bed is usually clearly greater because of the smaller inflow surface area in comparison with a rectangular apparatus, and this in turn results in a comparatively broad dwell time spectrum for the material to be treated, and therefore different product properties are sometimes produced. In general, also only one process step is possible in continuous apparatuses having a round geometry.

Furthermore, it is known, in the case of devices having a round apparatus geometry, to influence the process conditions by means of a short-term increase of the flow velocity of the gas that produces or maintains the fluidized bed, namely directly after it moves past the inflow bottom. In this connection, a gas-impermeable cone is disposed coaxially on the inflow bottom, in the case of a device for carrying out catalytic reactions in a fluidized bed, the base surface of which cone covers the center part of the inflow bottom, so that a ring-shaped process surface remains. The process space thereby consists of a ring space that widens conically upward (DE 1 052 367). By means of this configuration of the process space, uniform distribution of the solid catalyst particles in the zone of the fluidized bed is achieved, and agglomeration is counteracted. However, in this device, too, the fluidized bed is relatively high, so that the dwell time spectrum is very great and thus use of this device for continuous treatment of solids is not possible.

The invention and its advantages

The device according to the invention, for continuous treatment of solids in a fluidized bed apparatus having the characterizing features of the main claim, has the advantage, in comparison, that a solids flow that is uniformly directed in the horizontal direction is achieved over a longer distance, with a simultaneously flat fluidized bed, in a process space that is round in cross-section. This longer distance, which the solids particles cover from their entry into the process space until their exit from it, is formed by a circular ring surface that is interrupted by a partition wall, i.e. a surface that is not completely closed. By means of the placement of the inlet and the outlet on the two sides of the partition wall, the material to be treated is forced to pass along this circular ring surface, i.e. the distance between the solids inlet and the solids exit is maximized at the smallest possible space requirement. In this way, the advantages of a device having a rectangular apparatus geometry with regard to a fiat fluidized bed having a uniformly directed solids flow and a narrow dwell time spectrum are combined with the construction advantages with regard to space requirement, low wall thickness, and easier pressure-resistant or pressure-surge-resistant design of a device having a round apparatus geometry. By means of the use of components that preferably have rotation symmetry, simpler production and an easier guarantee of close production tolerances is possible. Furthermore, the distortion of devices having a round apparatus geometry is less. The round apparatus geometry also allows a more precise adjustment of the flow geometry. The spatial closeness of solids inlet and solids outlet makes it easier to connect the device to feed and discharge equipment. Connection to process filter systems is also more advantageous. Finally, process spaces having a round cross-section can be cleaned more easily than those having a polygonal cross-section.

The term “round apparatus geometry” is understood to mean not only those having a circular cross-section shape, but also all other non-angular cross-section shapes, such as, for example, oval or elliptical.

The device according to the invention can easily be integrated into conventional fluidized bed apparatuses. It can be used to implement all the usual fluidized bed applications, such as, for example, adsorption, desorption, catalysis and regeneration of catalysts, drying, dehydrogenation, and calcination.

According to an advantageous embodiment of the invention, the partition wall projects all the way into the relaxation space that follows above the process space. In this way, solids that enter into the process space are prevented from mixing with the solids that have already been treated and are exiting.

In another advantageous embodiment of the invention, the region of the process space that extends from the solids inlet all the way to the solids outlet is divided into chambers that have a connection with one another. In this way, multi-stage processes can now also be implemented in a process space having a round cross-section.

According to an embodiment of the invention that is advantageous in this regard, the chambers are formed by intermediate walls that project radially into the process space. If these intermediate walls are configured as weirs, they are connected with the inner wall of the process space with their outer longitudinal edge, in each instance, and with the free longitudinal edge of the partition wall with their inner longitudinal edge, in each instance. The solids stream then moves past this weir over its upper edge or between its lower edge and the inflow bottom, depending on the design of its height. In the first case, its height is accordingly equal to or less than the height of the fluidized bed, while in the second case, its height is clearly greater than the height of the fluidized bed. The flow of the solids stream can also be influenced and made uniform by means of weirs.

In another embodiment of the invention, the weirs are clearly higher than the fluidized bed and extend all the way directly onto the inflow bottom. In this case, the solid moves past the weir by way of radial openings (either toward the outside edge or toward the inside edge or toward both edges). Furthermore, bores, recesses or other flow-through devices, as desired, are possible as passage openings.

According to a particularly advantageous embodiment of the invention, the height and/or the work angle of the partition wall, the intermediate walls and/or weirs is adjustable. In this way, different process conditions can be achieved in one and the same device, in quick and simple manner.

According to another advantageous embodiment of the invention, a displacer body is disposed on the inflow bottom, in the axis of the process space, which body is connected with the partition wall. This body closes off the gas passage openings of the inflow bottom with its base surface, so that a ring surface having a reduced width is formed between its outer mantle and the inside surface of the process space. The process conditions can also be influenced in this manner. Furthermore, the outer mantle of the displacer body serves for attaching other installations, such as weirs and intermediate walls.

Further advantages and advantageous embodiments of the invention can be derived from the following description, the drawings, and the claims.

### DRAWING

Exemplary embodiments of the invention are shown in the drawings and described in greater detail below. The drawings show:

FIG. 1 a representation of the principle of the invention,

FIG. 2 a spatial representation of the inside view of a device according to the invention, with a displacer body,

FIG. 3 the device according to FIG. 2 with an intermediate wall,

FIG. 4 the division of the process space into three chambers,

FIG. 5 a fundamental representation of the process space with an overflow weir, and

FIG. 6 a fundamental representation of the process space with an underflow weir.

### DESCRIPTION OF THE EXEMPLARY EMBODIMENT

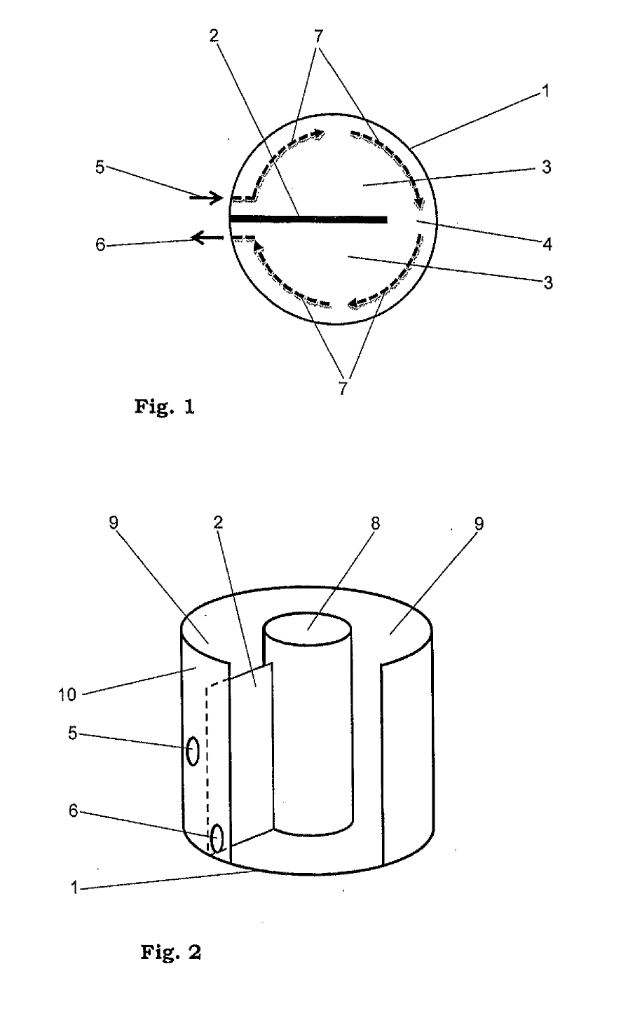

FIG. 1 shows the principle of a device according to the invention, whereby here, only the circumference of a circular inflow bottom 1 with a partition wall 2 standing perpendicular on it is shown, which wall projects from the circumference to far beyond the center of the inflow bottom 1, so that the process space 3 is divided into two regions of equal size, which are connected with one another at the free end of the partition wall 2 by means of a narrow region 4. The entry of the solid to be treated into the device takes place by way of an inlet opening that is indicated with an arrow 5 that points to the inflow bottom 1 in FIG. 1. Removal of the treated solid from the device takes place by way of an outlet opening that is indicated here by an arrow 6 that points away from the inflow bottom 1. The path of the stream that the solid moves along between the inlet and outlet opening 5, 6 is identified with the number 7. As a result of the placement of the inlet and outlet opening 5, 6 on both sides of the partition wall 2, the solid moves over the inflow bottom 1 while it is held in the fluidized bed. This path can be configured as a ring-shaped process space 9, as is evident from FIG. 2, by means of placement of a displacer body 8 in the center axis of the process space, which extends between the outer wall of the displacer body 8 and the wall 10 of the device. In this way, the path of the solids particles that are still situated close to the center axis of the device in the embodiment according to FIG. 1 and move along the partition wall 2 are now also forced into a circular track, so that the dwell time spectrum of a device configured in this manner is further narrowed. From FIG. 2, it is furthermore evident that the outlet opening 6 is disposed lower than the inlet opening 5. As a result, a natural gradient occurs between solids inlet and solids outlet, thereby facilitating removal of the treated solid from the apparatus.

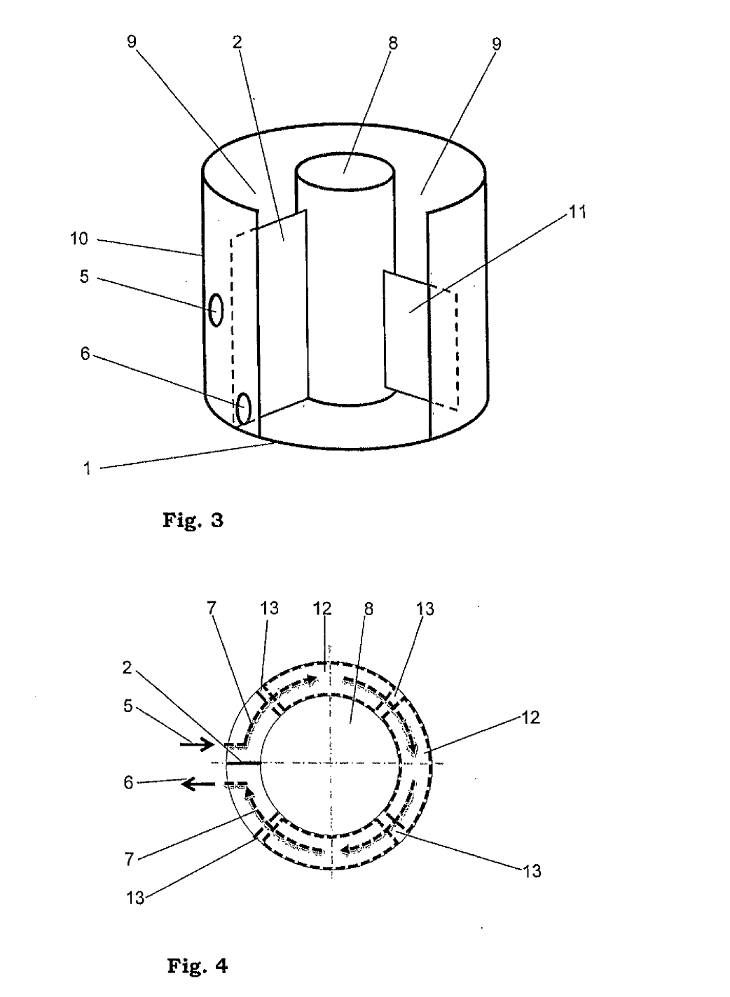

FIG. 3 shows the device shown in FIG. 2 with a weir 11 that is disposed in the process space 9 about two-thirds of the way from the inlet opening 5 to the outlet opening 6, and is connected, with its perpendicular edges, with the displacer body 2 on the one hand, and with the wall 10 on the other hand. The other components of the device that agree with the representation in FIG. 2 were provided with the same reference numbers. The weir 11 divides the process space 9 into chambers of different lengths. In this manner, the flow velocity of the solids stream that is situated in the fluidized bed is influenced.

As was already explained above, the ring-shaped process space 9 can be divided into multiple chambers by means of intermediate walls configured as weirs, in which chambers the solids stream can be exposed to different treatment or subjected to several method steps, in one and the same fluidized bed, as it passes through these chambers. In FIG. 4, this occurs fundamentally by means of three separate chambers 12 that are provided in the process space by means of four weirs 13 in the region after the inlet opening 5 and before the outlet opening 6 of the solid. Thus, it is possible, for example, to mix the solid in the first chamber 12, to carry out agglomeration in the subsequent chamber, and to conclude the process with drying in the last chamber 12. For agglomeration, nozzles, not shown here, are provided in the second treatment chamber 12, in order to continuously spray out a binder.

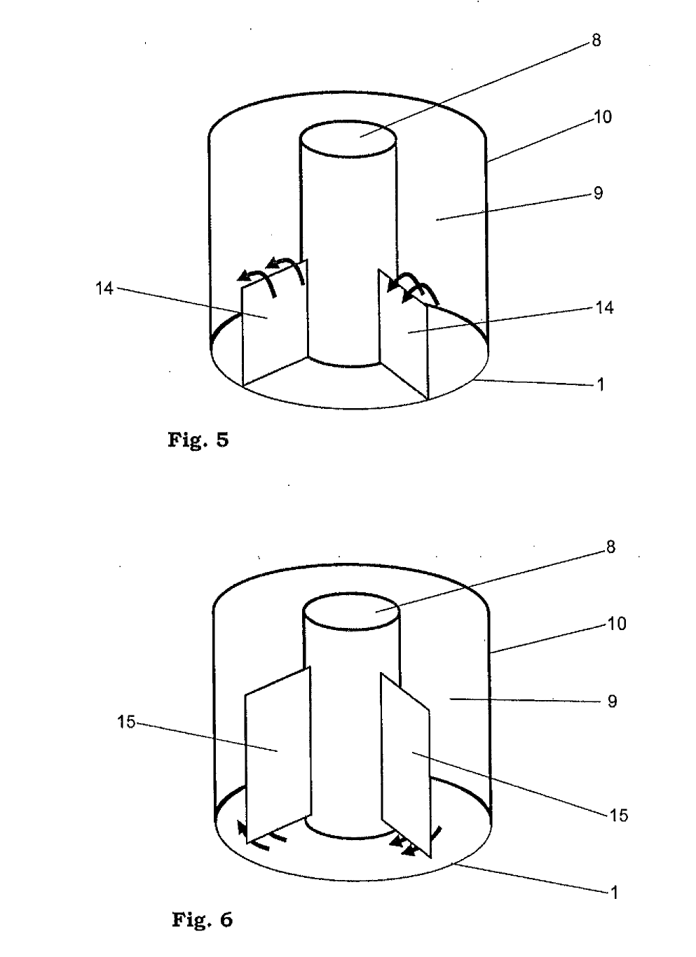

In FIGS. 5 and 6, two different forms of weirs are shown. The weirs shown in FIG. 5 are overflow weirs 14, the height of which is less than the height of the fluidized bed, so that the solids stream moves over the top edge of the overflow weirs 14 indicated with the arrows. In contrast to this, the solids stream moves through the interstice between the inflow bottom 1 and the lower edge of the underflow weirs 15, indicated with the arrows, the height of which weirs is dimensioned to be greater, in this case, than the height of the fluidized bed.

In conclusion, three methods that can be carried out in the device according to the invention will be described as examples:

1. Continuous Agglomeration of a Powder:

In a fluidized bed apparatus having a circular ring surface area of 5 dm², powdered lactose is continuously introduced at a metering amount of 5 kg/h. In the fluidized bed apparatus, fluidization takes place at an air amount of 150 m³/h and an air entry temperature of 70° C. Three two-substance spray nozzles are disposed in the region of the circular-ring-shaped process space 9; these nozzles spray a binder fluid, consisting of PVP (2% solution) onto the fluidized bed from above. As a result, the powder agglomerates to form a pourable product that flows easily, which product is continuously removed from the process space 9 through the outlet opening 6.

2. Drying of Extrudates:

A pharmaceutical power mixture for the production of tablets is granulated in an extruder, using a binder. The moist granulate formed in this process is continuously introduced into a fluidized bed apparatus having an inflow bottom surface area of 5 dm², at a mass stream of 10 kg/h. In this apparatus, a fluidized bed is built up by means of a drying volume stream of 120 m³/h at an air entry temperature of 50° C., and the granulate is thereby dried. The dried granulate is continuously removed at the outlet opening 6.

3. Spray Granulation of Maltodextrin

In a fluidized bed apparatus having an inflow surface area of 5 dm², a maitodextrin solution (30% dry substance proportion) is continuously sprayed into the fluidized bed from below, by way of three two-substance nozzles, at a total spraying rate of 10 kg/h. In the fluidized bed itself, a compact granulate is built up by means of a spray granulation process, in which granulate the solids component of the spray solution precipitates onto the particles contained in the fluidized bed, and the water component evaporates. The process takes place at an average temperature of 60° C. in the fluidized bed. The process air amount is 200 m³/h. The resulting granulate is continuously discharged from the fluidized bed by way of a zigzag sifter mounted to the side at the product outlet. In the sifter, classification takes place, in which granulate that is too small is removed by way of a classification air stream and passed back into the process space. Granulate having a sufficient size is removed as a product stream.

All of the characteristics shown in the specification, the following claims, and the drawing can be essential to the invention both individually and in any desired combination with one another.

### REFERENCE NUMBER LIST

1 inflow bottom

2 partition wall

3 process space

4 region

5 inlet opening

6 outlet opening

7 solids stream

8 displacer body

9 ring-shaped process space

10 wall

11 weir

12 chamber

13 weir

14 overflow weir

15 underflow weir

1. Device for continuous treatment of solids in a fluidized bed apparatus having a round process space, which has a solids inlet (5) and a solids outlet (6), and an inflow bottom (1) adapted to the inside contour of the process space (3, 9), below which a media inlet for producing and maintaining the fluidized bed is disposed,
wherein
a partition wall (2) is disposed on the inflow bottom (1), which wall projects from the inner wall (10) of the process space (3, 9) radially inward into the process space (3, 9), and wherein the solids inlet (5) is disposed close to the partition wall (2), on the one hand, and the solids outlet (6) is disposed close to the partition wall (2), on the other hand.

2. Device according to claim 1, wherein
the partition wall (2) projects all the way into the relaxation space that follows above the process space (3, 9).

3. Device according to claim 1,
wherein
the region of the process space (9) that extends from the solids inlet (5) all the way to the solids outlet (6) is divided into chambers (12) that are connected with one another.

4. Device according to claim 3,
wherein
the chambers (12) are formed by intermediate walls that project radially into the process space (9).

5. Device according to claim 4,
wherein
the intermediate walls are configured as weirs (11, 13, 14, 15).

6. Device according to claim 2,
wherein
the height of the chambers (12), intermediate walls and/or weirs (11, 13, 14) is equal to or less than the height of the fluidized bed.

7. Device according to claim 2,
wherein
the height of the chambers (12), intermediate walls and/or weirs (11, 13, 15) is clearly greater than the height of the fluidized bed.

8. Device according to claim 1,
wherein
the height and/or the work angle of the partition wall (2), the intermediate walls and/or weirs (11, 13, 14, 15) is adjustable.

9. Device according to claim 1,
wherein
a displacer body (8) is disposed on the inflow bottom (1), in the axis of the process space (9), which body is connected with the partition wall (2).

10. Device according to claim 9,
wherein
individual ones or all of the intermediate walls and/or weirs (11, 13, 14, 15) are connected with the displaces body (8).
